(19) United States
(12) Patent Application Publication
(10) Pub. No.: US 2004/0068672 A1
(43) Pub. Date: Apr. 8, 2004

(54) Lower power disk array as a replacement for robotic tape storage

(75) Inventors: Ian Fisk, San Diego, CA (US); Michael Mojaver, Poway, CA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: Tempest Microsystems, San Diego, CA (US)

(21) Appl. No.: 10/394,964

(22) Filed: Mar. 21, 2003

Related U.S. Application Data
(60) Provisional application No. 60/366,202, filed on Mar. 21, 2002.

(51) Int. Cl. G06F 12/00

(52) U.S. Cl. 713/323; 711/114

(57) ABSTRACT

The present invention provides methods and systems for storage of data. In one aspect, the invention provides a data storage system that includes a plurality of storage devices, such as, disks, for storing data, and a controller that implements a policy for managing distribution of power to the storage devices, which are normally in a power-off mode. In particular, the controller can effect transition of a storage device from a power-off mode to a power-on mode upon receipt of a request for reading data from or writing data to that storage device. The controller further effects transition of a storage device from a power-on mode to a power-off mode if no read/write request is pending for that storage device and a selected time period, e.g., a few minutes, has elapsed since the last read/write request for that storage device.

### RELATED APPLICATIONS

The present application claims priority to a provisional application entitled “A lower power disk array as a replacement for robotic tape storage” filed on Mar. 21, 2002 and having Application Serial No. 60/366,202. This provisional application is herein incorporated by reference.

### BACKGROUND

The present invention relates to methods and systems for storing data, and more particularly, to cost-effective methods and systems for storage and retrieval of a large amount of data, e.g., in a range of tens to hundreds of Terabytes.

The volume of data generated by business processes in variety of organizations is increasing exponentially with time. Most industrial and business processes are far more efficient in generating digital data than in utilizing it. As a result, the demand for long-term data storage and back-up is growing rapidly. Currently, large scale data warehousing is typically implemented by employing tape media, which suffer from long access latency, namely, the time required for loading the tape and other associated access times. In addition, robotic tape systems are bulky and expensive to maintain.

Since the latency period for access to database items located in a tape archive is typically on the scale of tens to hundreds of seconds, a system overload frequently arises when a database search requires access to data located on many or all of the tapes in a library. Improving robotic tape storage access presents a challenging problem. Even with multiple arms and tape drives, access within each tape remains serial with few opportunities for speeding up access to data. Soft-ware approaches that streamline tape access by clustering and de-clustering multiple accesses are known. These approaches can improve performance of Petabyte tape libraries that include several hundred Terabytes of disk cache. These approaches, however, can not eliminate the fundamental limitations arising from tape access latency.

Magnetic disk storage currently available presents an alternative to tape. Current commodity disk drive units are only marginally more costly than tape media and will be less costly within a few years, if current trends continue.

However, disk-based systems having very large storage capacities, for example, hundreds of Terabytes, are very costly, and offer short retention life in comparison to tape. Redundant Arrays of Inexpensive Disks (RAID) include a small number of disk drives, and an interface that presents these drives as a single large disk to a user while protecting data loss in case of failure of any of the disks. Current RAID systems have maximum storage capacity of approximately a Terabyte, and are optimized for random access speed.

A storage area network (SAN) provides a practical approach for combining many RAID modules to obtain high storage capacity, for example, tens of Terabytes, albeit at high cost. Networked Attached Storage (NAS) devices provide another alternative for high capacity disk storage. A NAS cluster relies on the scalability of networks in a file server topology to provide high storage capacity. However, similar to SAN, NAS devices can also be costly.

Accordingly, there is a need for cost effective methods and systems for high speed, and high capacity storage of data.

### SUMMARY OF THE INVENTION

The present invention provides in one aspect a data storage system that includes a plurality of storage devices, for example, tens or hundreds of storage devices such as disks, for storing data, and a controller that is coupled to these storage devices via a bus or any other suitable device. The storage devices, which preferably provide permanent data storage, are normally in a power-off mode. That is, in the absence of processing an input/output (I/O) request, each storage device is decoupled from a power source that would otherwise supply power (e.g., electrical power) to that storage device.

The controller, which can be programmed in software or in hardware, effects transition of a storage device from a power-off mode to a power-on mode upon receipt of a request for access to that storage device, for example, for reading data from or writing data to that storage device, i.e., a read/write request. When storage devices are disks, this approach effectively treats the disks as inexpensive tape drives.

The controller can be implemented as a central device to manage power distribution to all storage devices in a manner described above. Alternatively, a plurality of controllers, each managing power distribution to each individual storage device or a group of storage devices, can be employed. Hence, the term “controller,” as used herein, is intended to refer to a single central control device or a plurality of devices that collectively implement a policy for distributing power to a plurality of storage devices according to the teachings of the invention.

In a related aspect, the controller further effects transition of a storage device from a power-on mode to a power-off mode if no access request, e.g., no read/write request, is pending for that storage device and a selected time period, e.g., a few seconds, a few minutes, or a few hours, has elapsed since the last read/write request for that storage device.

A variety of storage devices can be utilized in a system according to the invention. Such storage devices include, but are not limited to, magneto disks and optical media. Each storage device can have a data storage density in a range of about 100 Megabytes per cubit centimeter to about 1 Gigabytes per cubic centimeter, and more preferably in a range of about 100 Megabytes per cubic centimeter to about 10 Gigabytes per cubic centimeter. A group, or the entire, of storage devices can be housed in an enclosure (chassis), and a plurality of chassis can be disposed on a rack. The storage devices in a system of the invention can provide, for example, a collective storage in a range of about 25 TB to about 50 TB per chassis and in a range of about 250 TB to about 500 TB per rack. Further, the storage devices can form a RAID storage system. It should be understood that as the storage capacity of storage media suitable for use in a system of the invention increase, the collective storage capacity, or in other words, data storage density, provided by a system of the invention can also increase.

In another aspect, a storage system of the invention as described above, can include a relay coupled to the controller that receives signals from the controller, and electrically connects or disconnects one or more selected ones of the storage devices to a source of power.

In further aspects, a data storage system according to the invention can include a cache storage, having, for example, a cache memory and a cache disk, coupled to the controller for storing selected data retrieved from one or more of the storage devices. This is particularly useful for rapid access to data that is likely to be requested in the future by one or more processes. For example, in some embodiments, when an executing process requests data corresponding to a portion of file residing on one of the storage devices, the controller would retrieve the entire file, transmit the requested portion to the executing process, and store the entire file on the cache storage. In the likely event that the executing process requests access to another portion of the file, the requested portion can be rapidly retrieved from the cache storage.

In another aspect, the present invention provides a method for managing power distribution to a plurality of storage devices that calls for effecting transition of each storage device from a power-off mode to a power-on mode upon receipt of a request for writing data to or reading data from that storage device. The method further calls for effecting transition of a storage device from a power-on mode to a power-off mode if no read/write request is pending for that storage device, and a selected time period has elapsed since the receipt of the last read/write request.

In further aspects, the invention provides an improved data storage system having a plurality of storage devices disposed in an enclosure, herein also referred to as a chassis, so as to provide a data storage density in a range of about 50 Megabytes per cubic centimeter to about 0.5 Gigabytes per cubic centimeter, or preferably a data storage density in a range of about 100 Megabytes per cubic centimeter to about 1 Gigabytes per cubic centimeter, or more preferably in a range of about 100 Megabytes per cubic centimeter to about 10 Gigabytes per cubic centimeter. One or more controllers coupled to the storage devices implement a power distribution policy as described above for supplying electrical power to the storage devices. More particularly, the controllers can effect transition of one or more storage devices from a power-off mode to a power-on mode upon receipt of a request for accessing those storage devices, and can further effect transition of one or more storage devices from a power-on mode to a power-off mode if no access requests are pending for those storage devices and a selected time period has elapsed since the last access request for those storage devices.

Further understanding of the invention can be obtained by reference to the following detailed description in conjunction with associated drawing, which are described briefly below.

### BRIEF DESCRIPTION OF THE DRAWINGS

FIG. 1 schematically illustrates an exemplary data storage system according to the teachings of the invention,

FIG. 2 is a block diagram depicting various steps in a method according to the teachings of the invention for managing power distribution to a plurality of storage devices,

FIG. 3 is a diagram illustrating cost/performance characteristic of an exemplary data storage system of the invention relative to a number of conventional systems,

FIG. 4 is a diagram schematically depicting an exemplary prototype data storage system built according to the teachings of the invention, and

FIG. 5 schematically depicts the storage devices of FIG. 4 housed in an enclosure.

### DETAILED DESCRIPTION

The present invention provides systems and methods for cost-effective storage and retrieval of a large amount of data while minimizing physical space required for such storage. As discussed in more detail below, a system of the invention can include a plurality of selected storage media, e.g., disks, which can be, for example, packed in an enclosure in close proximity of one another. Each storage medium is normally in a power-off state in order to alleviate the thermal load of the system. A controller is utilized to transition a selected one of the storage media from a power-off mode into a power-on mode in order to read data from and/or write data to that storage medium.

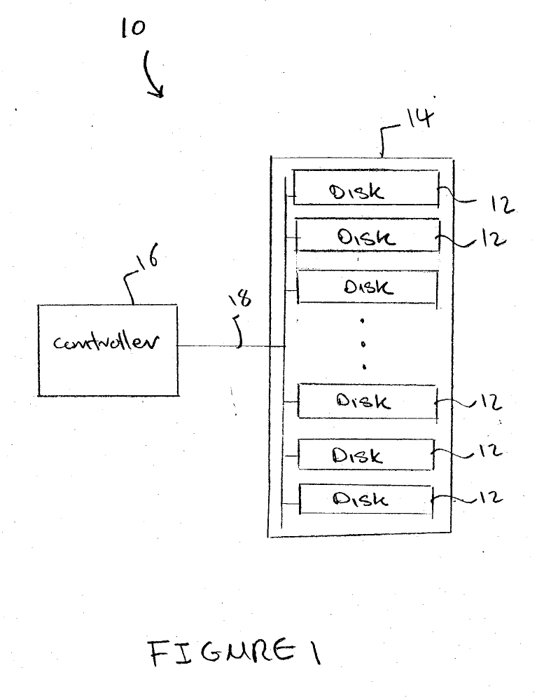

With reference to FIG. 1, an exemplary data storage system 10 according to the teachings of the invention includes a plurality of storage devices 12, for example, disks, provided in an enclosure 14, and a controller 16 that can communicate with the storage devices 12 via, for example, a bus 18. The controller 16 can be housed within the enclosure 14, or alternatively, it can be provided external to the enclosure. The controller 16 can effect the transition of each storage device 12 from a power-off mode, i.e., a mode in which the storage device is disconnected from power, to a power-on mode, i.e., a mode in which power is delivered to the storage device, upon receipt of a read/write request for that storage device. That is, an idle storage device, i.e., a storage device for which no read or write request has been received for a selected period of time and for which no request is pending, is maintained in a power-off mode, and is only powered up when a read/write request is received.

The controller 16 can further effect the transition of a storage device 12 from a power-on mode to a power-off mode if no read/write request is received and/or pending for that storage device and a selected time period, for example, a time period in a selected range, e.g., in a range of a few seconds to a few hours, has elapsed since the last read/write request for that storage device.

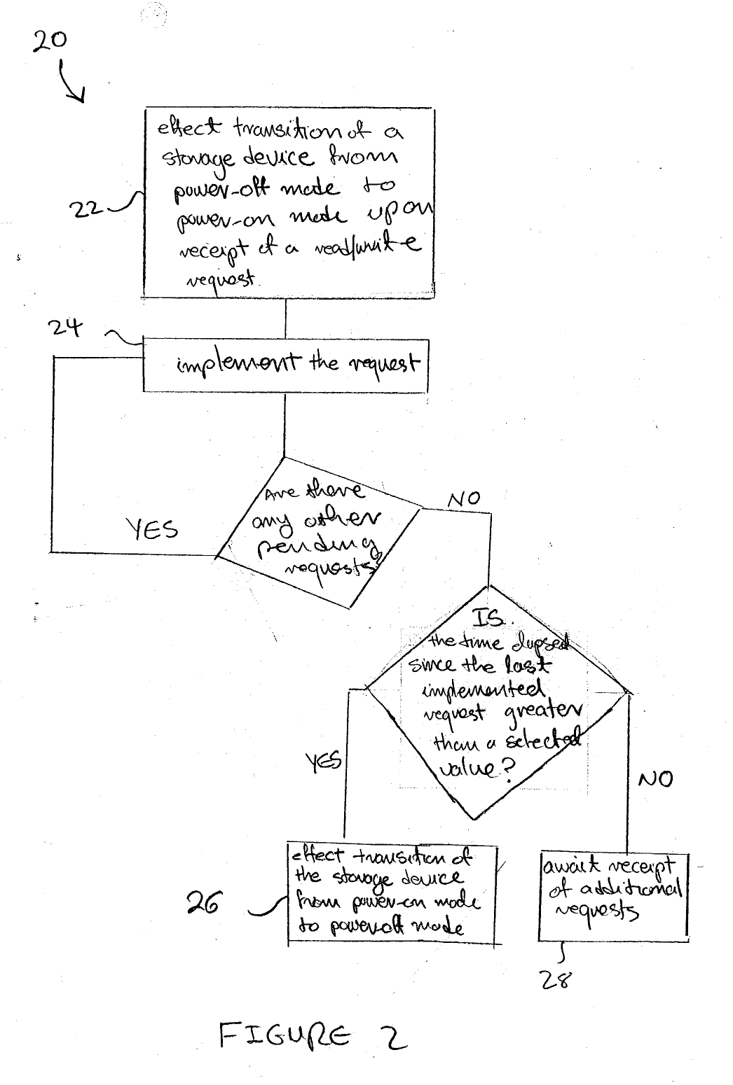

A method according to the teachings of the invention for managing power distribution to a plurality of storage devices, implemented by the exemplary data storage system 10, can be perhaps better understood by reference to a flow chart 20, shown in FIG. 2, that describes various steps of such a method. In particular, in step 22, an idle storage device for which a read/write request is received is effected to transition from a power-off mode to a power-on mode, and, in step 24, the read/write request is implemented. Further, any other pending requests associated with that storage device is also implemented.

With continuing reference to the flow chart 20, in the absence of any pending requests, and if the time elapsed since the receipt of the last implemented request exceeds a selected value, in step 26, the power to the storage device is disconnected, i.e., the storage device is effected to transition from a power-on mode to a power-off mode. Otherwise, the system awaits receipt of additional read/write requests, if any (step 26).

A data storage system according to the teachings of the invention provides a number of advantages over conventional systems. For example, conventional RAID devices typically utilize about 10 drives per enclosure to meet the power and thermal limitations of fast disk drives. In contrast, a data storage system of the invention allows an order of magnitude more drives to be supported in the same enclosure by substantially reducing power dissipation of the drives. That is, a data storage system of the invention utilizes a policy for managing distribution of power to a plurality of storage devices, as described above, that reduces the overall power consumption of the system. This allows a more compact configuration for the storage system, and also allows more disk drives to share the same electronics control system, thereby lowering the cost of manufacturing.

Further, an initial access latency to a storage device that is in a power-off mode in a data storage system of the invention can be approximately 10 seconds. This access latency is comparable to the best case, i.e., tape drive is empty and data is located at the beginning of the tape, access time for robotic tape libraries. Any additional access for performing read/write operations in data storage system of the invention will be at full random access speed.

Moreover, as discussed above, in a system of the invention, the storage devices, e.g., disks, are normally in a power-off state. This advantageously reduces wear and tear experienced by each storage device if it is accessed infrequently, thereby lengthening its shelf life. For example, magnetic disks cease to spin when transitioned into a power-off state, and hence experience less wear and tear in this state.

In some embodiments of the invention, techniques can be utilized to maintain the most frequently accessed drives highly available, for example, by lengthening the inactive period after which the device is transitioned to a power-off mode.

A direct disk peripheral interface can enhance database performance by eliminating the software overhead associated with distributed networked storage. The expected data storage I/O rate can be supported using a high speed interface.

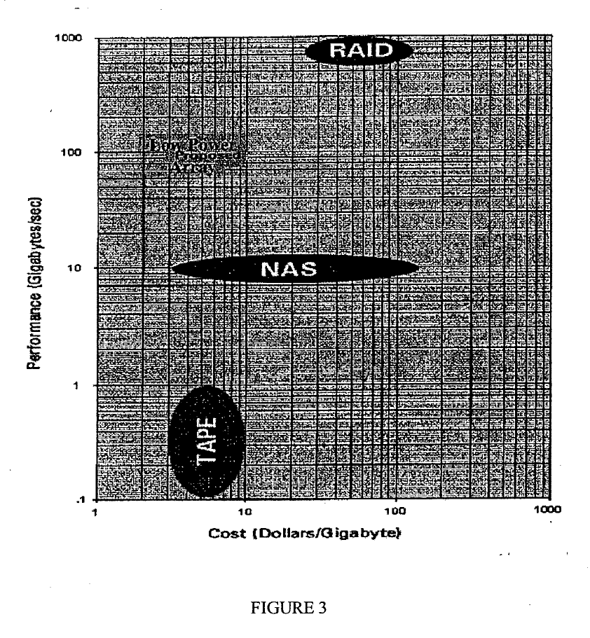

FIG. 3 schematically depicts the cost/performance characteristics of an exemplary data storage system of the invention having an array of disks relative to those of a number of conventional storage systems. The graph of FIG. 3 plots performance versus cost (in a log-log scale). As shown in this figure, a data storage system of the invention can provide considerably enhanced performance relative to tape libraries or NAS devices at comparable or reduced cost. Further, a data storage system of invention can be less costly than a conventional RAID system.

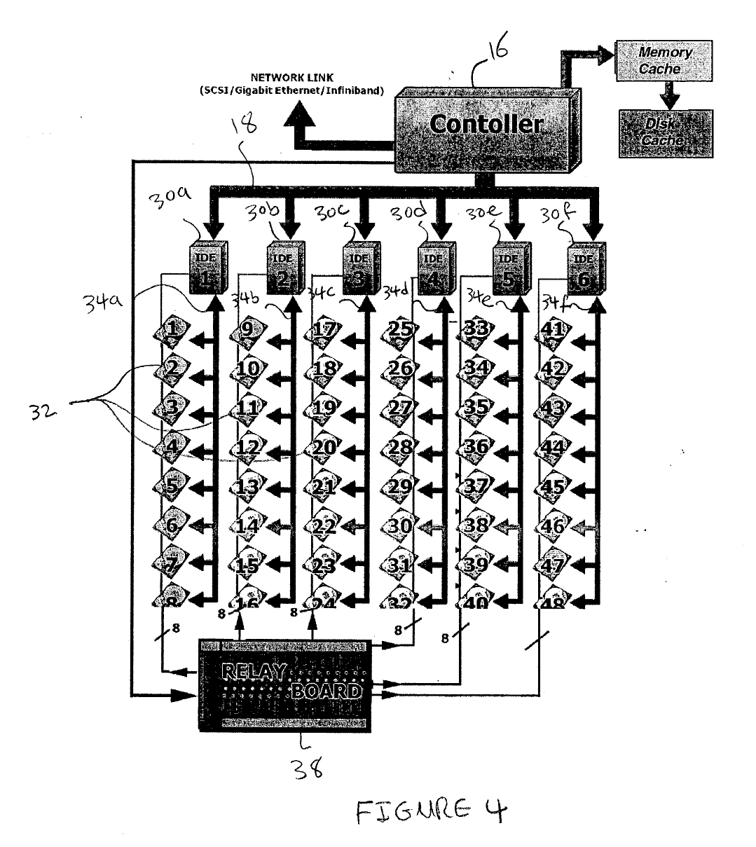

In order to demonstrate the feasibility of manufacturing a storage system according to the teachings of the invention, and the efficacy of such a system for storage and retrieval of a large amount of data, a prototype system was built and tested. FIG. 4 schematically illustrates that this prototype system includes a controller 16 that can communicate, via a bus 18, with a plurality of hard disk drive interfaces 30a-30f, herein collectively referred to as drives 30, operating based on Integrated Drive Electronics (IDE) interface standard. The drives 30 communicate and control a plurality of hard disks 32 via buses 34a-34f. More particularly, in this exemplary prototype, each hard disk drive 30 controls access to eight hard disks, each of which has a storage capacity of about 200 Gigabytes.

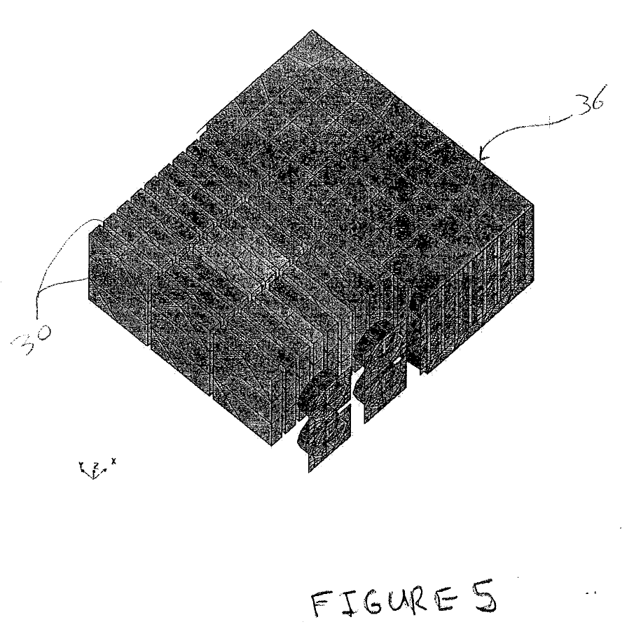

The hard disks 30 are housed in an enclosure 36, schematically depicted in FIG. 5, having approximate dimensions of 24 inches by 19 inches by 6 inches (approximately 60 cm×50 cm×15 cm). Although only 48 drives are utilized in this exemplary prototype, it should be understood that a system of the invention can be constructed with hundreds of disks to provide a collective storage capacity in a range of about 25 Terabytes to about 50 Terabytes per chassis and a storage capacity in a range of about 250 to about 500 Terabytes per rack.

Referring again to FIG. 4, the hard disks 32 are normally in a power-off mode. The controller 16 can cause the transition of one or more of the hard disks from a power-off mode to a power-on mode upon receipt of a request for accessing those hard disks. More particularly, the controller 16 can send signals to a relay board 38 for supplying power to one or more selected ones of the disks 32. Alternatively, the controller 16 can send signals to the relay board 38 for disconnecting one or more selected ones of the disks 32 from a source of power (not shown in this figure). For example, if a disk that is in a power-on mode is not accessed for a selected time period, e.g. a time period in a range of a few seconds to about a few minutes (e.g., 15 minutes), the controller can instruct the relay board to shut off power to that disk.

In this exemplary prototype, the controller 16 implements a plurality of requests for accessing the hard disks on a FIFO (first-in-first-out) basis. Those having ordinary skill in the art will appreciate that any other suitable algorithm for processing the requests can also be utilized. While the available power is typically the primary factor that determines the maximum number of disks that can be simultaneously switched on, it is an acceptable level of thermal load that typically provides an upper limit for the maximum number of disks that can be simultaneously in a power-on state. This upper limit imposed by the thermal load depends in general not only on the number of disks that are in a power-on state but also on their distribution within the enclosure. For example, more disks can be in a power-on state if they are sparsely distributed. In this exemplary prototype, it is feasible to have about 25 percent of the disks in a power-on state without encountering any thermal overload. It should, however, be understood that this exemplary prototype is provided only as an example, and the 25 percent limit is not intended to indicate an absolute upper limit in other embodiments of the invention. In particular, various improvements, including providing better thermal insulation and/or cooling mechanisms, can be employed to increase the maximum number of disks that can be simultaneously in a power-on state.

When the controller 16 receives a request for access to a disk that is in a power-off state while the number of other disks that are in the power-on state has reached an upper threshold imposed by the thermal load, the controller 16 can suspend access to one of the disks that is already in a power-on state, and transition that disk to a power-off state, in order to allow switching on the requested disk that is in a power-off state. The selection of a disk to be transitioned into a power-off state to allow transitioning a new disk from a power-off state to a power-on state can be performed based on a FIFO protocol, although other protocols can also be employed. In a FIFO protocol, a disk that has been in a power-on state for the longest time period is the first to be selected for being transitioned into a power-off state. If the selected disk is presently processing an input-output (I/O) request, the I/O processing can be blocked before transitioning the disk into a power-off state. The blocked I/O processing can, however, be scheduled to resume once the disk can be switched back on without causing thermal overload, for example, once one or more other disks have been switched off. A scheduler can manage the blocking and resumption of the I/O requests based on a selected scheduling protocol. Such a scheduler can be built, for example, as a kernel process or alternatively as a multithreaded user program.

With continued reference to FIG. 4, the exemplary controller 16 is also in communication with a memory cache 40, which can in turn communicate with a disk cache 42 for storing selected data retrieved from any of the hard disks 32. The data stored on the memory cache or the disk cache can be subsequently retrieved, if desired, very rapidly. In this exemplary protocol, when the controller receives a request for retrieval of a portion of a file residing on one of the disks, the controller retrieves the entire file, or an entire directory in which the file resides. The requested portion is transmitted to the process requesting it, and the entire file or directory is stored on the cache 42. This allows rapid retrieval of any other portion of the file, or other files in the directory, upon future requests.

In this exemplary prototype, the disks 32 are configured as a RAID system. For example, four disks are transitioned together from a power-off to a power-on mode, or vice versa, so as to allow maintaining data redundancy. It should be clear, however, that in an alternative embodiment, each of the disks can be accessed individually.

Further, the controller 16 can include a network interface for linking the controller to a selected network, for example, a storage area network (SAN).

Those skilled in the art will appreciate that various modifications can be made to the above embodiments without departing from the scope of the invention. For example, the data storage capacity of each storage device utilized in a system of the invention can be different than those recited above.

What is claimed is:

1. A data storage system, comprising:
a plurality of storage devices for storing data, and
a controller coupled to the storage devices to effect transition of one or more of the storage devices from a power-off mode to a power-on mode upon receipt of a read/write request for those storage devices, the controller further effecting transition of a storage device from a power-on mode to a power-off mode if no read/write request is pending for that storage device and a selected time period has elapsed since the last read/write request for that storage device.

2. The data storage system of claim 1, wherein the plurality of the storage devices form a RAID storage system.

3. The data storage system of claim 1, wherein each of the plurality of the storage devices is normally in a power-off mode.

4. The data storage system of claim 1, wherein said plurality of storage devices provide a collective data storage capacity in a range of about one hundred Terabytes to a few hundred Terabytes.

5. The data storage system of claim 1, wherein said plurality of storage device provide a collective data storage capacity in a range of tens of Terabytes to a few hundred Terabytes.

6. The data storage system of claim 1, wherein said plurality of storage device provide a collective data storage capacity in a range of about 50 Terabytes to about 100 Terabytes.

7. The data storage system of claim 1, wherein each of said plurality of storage devices provides a data storage density in a range of about 100 Mbytes per cubit centimeter to about 10 Gigabytes per cubic centimeter.

8. The data storage system of claim 1, wherein each of said plurality of storage devices provides a data storage density in a range of about 100 Mbytes per cubit centimeter to about 1 Gigabytes per cubic centimeter.

9. The data storage system of claim 1, wherein each of said storage devices can be any of a magnetic disk or an optical storage disk.

10. A data storage system, comprising
a plurality of storage devices for storing data, each storage device being normally in a power-off mode, and
a controller coupled to the storage devices to effect transition of one or more selected ones of said storage devices from a power-off mode to a power-on mode upon receipt of a request for accessing said selected storage devices.

11. The data storage system of claim 10, wherein the controller effects transition of one or more of said selected storage devices from a power-on mode to a power-off mode if no access request is pending for said one or more storage devices for a selected time period.

12. The storage system of claim 10, wherein said storage devices provide permanent data storage.

13. The storage system of claim 10, wherein said storage devices are housed in one or more enclosures.

14. The storage system of claim 13, wherein said enclosures are disposed in one or more racks.

15. The storage system of claim 13, wherein each of said enclosures provides a storage capacity in a range of about 25 to about 50 Terabytes.

16. The storage system of claim 14, wherein each of said racks provides a storage capacity in a range of about 250 to about 500 Terabytes.

17. The storage system of claim 10, wherein said storage devices comprise any of a magnetic hard disk or an optical storage medium.

18. The storage system of claim 10, further comprising a relay electrically coupled to said controller for receiving signals from said controller to connect or disconnect one or more selected ones of said storage devices to a source of power.

19. The storage system of claim 10, further comprising a cache storage medium in communication with said controller for storing selected data retrieved from one or more of said storage devices.

20. A method for managing power distribution to a plurality of storage devices,
effecting transition of a storage device from a power-off mode to a power-on mode upon receipt of a request for writing data to or reading data from that storage device, and
effecting transition of a storage device from a power-on mode to a power-off mode if no read/write request is pending for that storage device and a selected time period has elapsed since the receipt of the last read/write request.

21. The method of claim 20, wherein said time period is selected to be in a range of about a few seconds to about a few hours.

22. The method of claim 21, wherein said time period is selected to be in a range of about a few minutes to about a few hours.

23. In a data storage system, the improvement comprising:
a plurality of storage devices disposed in an enclosure so as to provide a data storage density in a range of about 100 Megabytes per cubic centimeter to about 10 Gigabytes per cubic centimeter, said storage devices being normally in a power-off mode, and
one or more controllers coupled to said storage devices to effect transition of one or more storage devices from a power-off mode to a power-on mode upon receipt of a request for accessing those storage devices, the controller further effecting transition of one or more storage devices from a power-on mode to a power-off mode if no access requests are pending for those storage devices and a selected time period has elapsed since the last access request for those storage devices.

24. The data storage system of claim 23, wherein said storage devices disposed in said enclosure provide a storage data density in a range of about 100 Megabytes per cubic centimeter to about 1 Gigabytes per cubic centimeter.

25. The data storage system of claim 23, wherein said access request can be a request for reading data from or writing data to a storage device.
